(19) United States
(12) Patent Application Publication
(10) Pub. No.: US 2004/0176067 A1
(43) Pub. Date: Sep. 9, 2004

(54) Method and system for Short Message Service (SMS) rating and billing

(76) Inventors: Shailesh Lakhani, Mississauga (CA); Rubens Rahim, Markham (CA)

Correspondence Address: REDKNEE INC., 2560 MATHESON BLVD. EAST, SUITE 500, MISSISSAUGA, ON, L4W4W9, CA

(21) Appl. No.: 10/353,995

(22) Filed: Jan. 30, 2003

(51) Int. Cl. H04M 11/00

(52) U.S. Cl. 455/406; 455/408

(57) ABSTRACT

The Improved Method and System for Short Message Service (SMS) Rating and Billing disclosed herewith presents telecommunications network operators (and related) with the opportunity to rate SMS traffic on its own pre-defined relative value and/or merits, as opposed to the customary peg count or volume based measure. Indeed, the art may be directed towards classifying and rating SMS messages based upon any number of attributes and variables including, inter alia, time-of-day (T-O-D), origination address, destination address, and message content (e.g. text vs. ring-tones).

### CROSS-REFERENCE TO RELATED APPLICATIONS

Patent application Ser. No. 10/307335 entitled “Improved method for implementing an Open Charging (OC) middleware platform and gateway system”.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND ART

As the popularity, utility and ubiquity of Short Message Service (SMS) grows within North America (and owing to the existing maturity of it within markets as, inter alia, the European Common Market), telecommunications network operators (including wireless operators) undoubtedly will and/or are requiring technology of increasing sophistication to manage allied rating and billing issues. In addressing this, the prior art demonstrates considerable weaknesses and limitations.

Consider, U.S. Pat. No. 6,473,622 to Meuronen, entitled Billing mobile terminated short messages, which discloses methods (and equipment) relevant to implementing the billing of short messages (SM) within mobile telephony. According to the specification, “the method comprises steps wherein a message is submitted to a short message service centre to be delivered to a subscriber; the message is delivered from the short message service centre to the mobile station of the subscriber via the mobile communication system; and at least one charge record is created per each transferred short message.” Needless to say, the advances represented by our invention of present, remain relevant to both mobile terminated (MT) and mobile origination (MO) short messages, and indeed architectural disparity aside, speaks specifically to the differentiated billing of SM traffic and even of the logic required to bar such messages where appropriate.

Additionally, U.S. Patent Application No. 20020029189 by Titus, et al., entitled Prepaid short messaging, details a method and apparatus for handling prepaid messaging service wherein a short message is tariffed before transmission by querying an account database. Our invention provides the capability to integrate with different SCPs using any number of protocols (including CAMEL, INAP, or TCP/IP). This enables and proffers the telecommunications network operator a centralized subscriber prepaid account database for different types of services such as SMS, MMS, Voice, etc. Indeed, the patent application by Titus et al., uses an internal database for prepaid SMS balance only.

In addition to which, our invention retains the capability to relay SMS traffic (through, for instance, SMPP or UCP protocols) into the SMSC and furthermore, the approach suggested by Titus et al.'s patent application require(s) changes to the said SMSC to support triggering thereof.

Additionally, Titus et al. also does not teach or suggest a method of utilizing existing pre-paid infrastructure which may have already been deployed for the purpose of supporting pre-paid circuit switched services. Nor does it teach or suggest a method of providing a rating rules engine for the purpose of characterizing the nature of and rating SMS traffic in an efficient manner. And indeed, it seems to presume that each message is delivered successfully.

And aside from supporting both prepaid and postpaid billing, our Improved Method and System for Short Message Service (SMS) Rating and Billing allows messages (MO and MT) to be rejected immediately (e.g. in case of insufficient balance) before such message(s) are even relayed to the SMSC. Thereby reducing the capacity requirement for the SMSC, and indeed allows for seamless integration with said SMSC.

### REFERENCES CITED

| | | | |
|---|---|---|---|
| U.S. Patent Application | Mar. 2002 | Titus, et al. | 705/39 |
| 20020029189 | | | |
| U.S. Pat. No. 6,473,622 | Oct. 2002 | Meuronen | 455/466 |

### TECHNICAL FIELD

The present invention relates generally to telecommunication network implementations; and in particular to an improved method and system for Short Message Service (SMS) rating and billing.

### SUMMARY OF THE INVENTION

The Improved Method and System for Short Message Service (SMS) Rating and Billing disclosed herein provides for real time, rating and billing of mobile originated short messages via Signaling System 7 (SS7) from a telecommunication carrier's and/or network operator's Short Message Service Center (SMSC) onto an Intelligent Network (IN) Prepaid system. Practitioners skilled in the art will recognize that a variety of signaling systems, protocols and related technologies may be utilized without diluting the intent and scope of the invention of present.

The art has been crafted to accommodate for both mobile originated (MO) and mobile terminated (MT) Short Messages (SM). For the purposes of demonstration and elucidation herein, the MO Billing is accomplished through SS7 or SMPP Loop Server interfaces, whereas MT Billing is accomplished through a SMPP Relay interface. Practitioners skilled in the art will recognize that interfaces mentioned remain for the purposes of illustration, and that a variety of signaling systems, protocols and related technologies may be utilized without diluting the intent and scope of the invention of present.

Further to which, the Improved Method and System for Short Message Service (SMS) Rating and Billing has been preferentially embodied with the logic which would enable and disable SM services for given pre-paid mobile subscriber's via any number of suitable provisioning interface(s) should said subscriber's balance drop below a defined threshold.

### BRIEF DESCRIPTION OF THE DRAWINGS

FIG. 1 illustrates a typical, non-limiting embodiment of the system level architecture employed in the disclosure of present;

FIG. 1A details a Short Message Peer to Peer (SMPP) Loop Server method which permits the billing and rating of mobile originated short message which utilize the SMPP Protocol.

### DETAILED DESCRIPTION OF THE PREFERRED EMBODIMENTS

For the purposes of demonstration and elucidation herein, the MO Billing is accomplished through SS7 or SMPP Loop Server interfaces, whereas MT Billing is accomplished through a SMPP Relay interface.

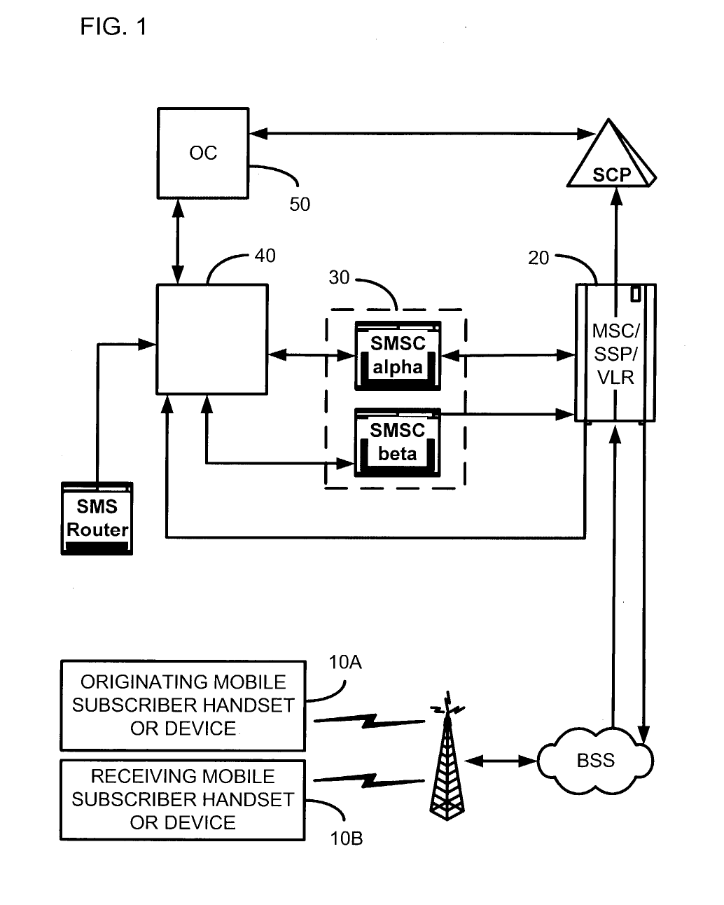

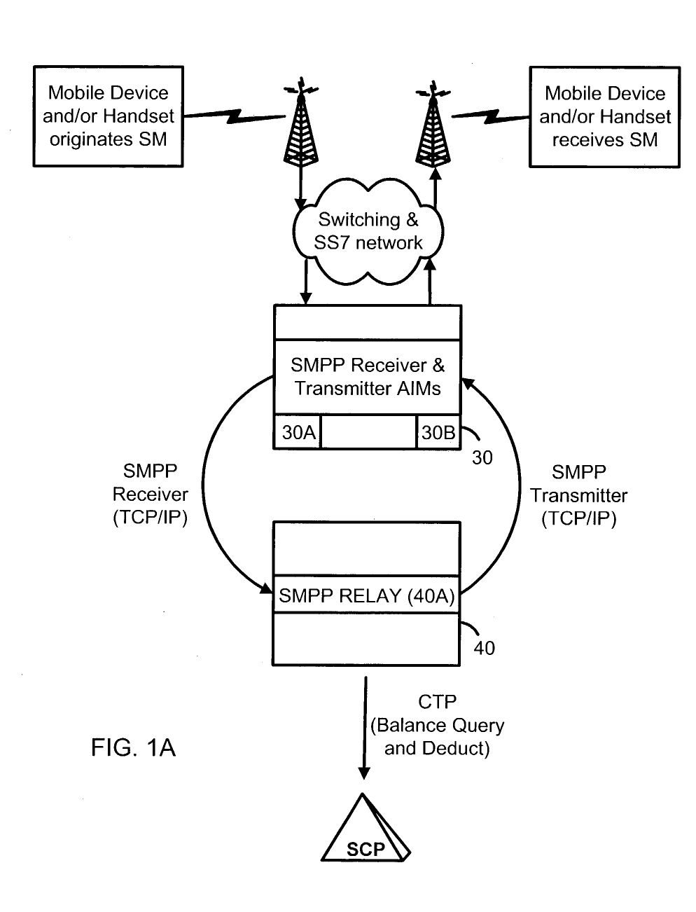

With reference to FIG. 1, for mobile originated (MO) 10A Short Message Service (SMS) traffic via an Signaling System 7 (SS7) Protocol, the Improved Method and System for Short Message Service (SMS) Rating and Billing's 40 SS7 MO Module (not shown) connects to telecommunication's network operator's Mobile Switching Centers (MSCs) 20 and Short Message Service Centers (SMSCs) 30 (via Signal Transfer Points (STPs), in this instance) to receive mobile originated SMS traffic. Practitioners skilled in the art will recognize that the signaling systems mentioned remain for the purposes of illustration and simplicity, and that a variety of signaling systems, protocols and related technologies may be utilized without diluting the intent and scope of the invention of present.

Being directly in the path of mobile originated traffic, the Improved Method and System 40 is able to rate in real-time messages before they are submitted to the SMSC (beta) for delivery. This enables carriers and/or telecommunications network operator's to ensure their Prepaid Subscribers have sufficient funds for sending messages, with no SMSC 30 modifications. STPs connected to 40 are responsible for routing the SMSC# used by the network to the Improved Method and System 40.

The Improved Method and System for Short Message Service (SMS) Rating and Billing 40 rates the incoming messages using its internalized Rating Rules (RR) (circumscribed in greater depth below). The method and system 40 then makes a request to an Open Charging (OC) middleware platform and gateway system 50 as detailed in patent application Ser. No. 10/307335 to ensure prepaid subscribers have sufficient funds in their prepaid account before the MO SM gets sent to the relevant SMSC. Where the account has insufficient balance, the MO message is rejected and in turn not delivered to the SMSC. Technicians skilled in the art will recognize that the invention of present need not be limited to the aforementioned Open Charging (OC) middleware platform and gateway system and other similar network implementations may be employed without diluting the intent and scope as such.

The internalized Rating Rules (RR) of the Improved Method and System for Short Message Service (SMS) Rating and Billing 40 determines the tariff for a message depending on the rate plans configured for that subscriber. And as such, may illustratively include originating or terminating address, time of day, day of week, holidays. The RR allow for considerable flexibility in setting the amount to be charged for a given message type. Indeed, the Improved Method and System 40 may be, in alternate embodiments, configured to charge on the message originator, message terminator, or both.

The RR architecture defines the procedure used to select a rule and the parameters available for rating a message or call. In the preferred embodiment, rules are considered in order according to priority assigned by the telecommunications network operator in question. The first rule that matches a given event's criteria will be used and all other rules will be ignored. The logic of the Internalized Rating Rules will ordinarily only consider rules with a service provider ID matching that of the incoming request. A rate can be charged based on the user's MSISDN or rate plan. Where both fields are provided within a rating request, the rate plan will be used to determine a rate. Should this method yield no rate, the MSISDN (in the alternative) will then be used to determine a rate.

In varying embodiment, where no rules match, the message/call will be assumed free of charge. Indeed, any non-billable messages/calls should be placed at the beginning of the rule set to allow for quick rating and discards, thereby advancing and augmenting the art. The currency that the charge is submitted in is a configurable parameter. The currency applies to all transactions and all rates are to that currency.

For ease of reference, the following table (Table 1) seeks to outline the rating rule architecture in a non-limiting, illustrative manner.

TABLE 1
Rating Rule Architecture

| Title | Description |
|---|---|
| Rule # | The Rule #. Rules are processed in this order, |
| | starting from 1 increasing to DEF. |
| SPID | The Service Provider this rule belongs to. |
| | Required for MSP compliance |
| Originating TON/NPI/ | The Originating MSISDN of the subscriber. |
| MSISDN | “RPx” for Rate Plan where x is the rate plan #, * |
| | for any. Partials allowed |
| Term TON/NPI/ | The Terminating MSISDN of the subscriber. |
| MSISDN | “RPx” for Rate Plan where x is the rate plan #, * |
| | for any. Partials allowed |
| Day | The day that this rule applies. This can be one |
| | of: Monday, Tuesday, Wednesday, Thursday, |
| | Friday, Saturday, Sunday, Weekdays (Mon-Fri), |
| | Weekends (Sat, Sun), Holidays (see Holiday |
| | table), Everyday (week) |
| Start Time | The Start Time, based on source application |
| | time, that the rule applies |
| End Time | The End Time, based on source application |
| | time, that the rule applies |
| Ported Number | Boolean representing charging for ported |
| | numbers. |
| Orig Flat Rate | The flat rate in local currency charged to the |
| | originating MSISDN |
| Term Flat Rate | The flat rate in local currency charged to the |
| | terminating MSISDN |
| Var Bill Interval | Billing interval (seconds) applicable to a call. |
| | For example, if a carrier sets this variable to 6, |
| | a 50 second call would be rated as a 54 second |
| | call. |
| Orig Var Rate | The variable rate in local currency charged to |
| | the originating MSIDN. If “B<ID>” is inserted |
| | into the field, it indicates that bucket rating |
| | applies and rates are determined from the |
| | BucketRateTable. |
| Term Var Rate | The variable rate in local currency charged to |
| | the terminating MSISDN. If “B<ID>” is inserted |
| | into the field, it indicates that bucket rating |
| | applies and rates are determined from the |
| | BucketRateTable. |

As the RR remain principal to the project at hand, it may be illustrative to render a sample rating structure. For instance, assume that there are two (2) Service Providers. Both Service Providers do not charge for MWI. The MWIs are generated from MSISDN 15149911123. Service Provider one (1) charges five (5) cents a message for both originating and terminating messages. Service Provider two (2) has unlimited mobile terminating but charges ten (10) cents for each mobile originated message. All of Service Provider one (1) subscribers are provisioned via the provisioning interface under Rate Plan one (1) and all of Service Provider two (2) subscribers are provisioned under Rate Plan two (2). Where messages are sent between 1900h and 1959 and only from Zone one (1) (national), a half-price applies to MO messages of five (5) cents. Otherwise, the full charge of ten (10) cents applies. To configure this, the RR would be created accordingly (Table 2) (some fields are omitted for brevity):

TABLE 2
Sample Rating Rule Set

| Rule | SPID | O.MSID | T.MISD | Start | Day | End | ZS | O.Rate | T.Rate |
|---|---|---|---|---|---|---|---|---|---|
| 1 | 1 | 15149911123 | * | 0000 | ED | 2359 | | 0 | 0 |
| 2 | 2 | 15149911123 | * | 0000 | ED | 2359 | | 0 | 0 |
| 3 | 1 | RP1 | * | 0000 | ED | 2359 | | 5 | 0 |
| 4 | 1 | * | RP1 | 0000 | ED | 2359 | | 0 | 5 |
| 5 | 2 | RP2 | * | 1900 | ED | 1959 | 1 | 5 | 0 |
| 6 | 2 | RP2 | * | 0000 | ED | 2359 | | B1 | 0 |
| 7 | 2 | * | RP2 | 0000 | ED | 2359 | | 0 | 0 |
| 8 | * | * | * | 0000 | ED | 2359 | | 0 | 0 |

In alternate embodiments as MO SM billing evolves, and with reference to FIG. 1A, should the carrier or telecommunications network operator in question wish to utilize Short Message Peer to Peer (SMPP) to provide mobile originated short message billing, an SMPP Loop Server (SMPP LS) method has been devised which allows billing of mobile originated short messages by having the SMSC route all messages through a SMPP receiver interface. Whereby the SMSC 30 (30A conceptually) is configured to route inbound SMs to a SMPP Receiver Applications Interface Module (AIM), and additionally where the TON/NPI (Type-Of-Number and Numbering Plan Identification, respectively) are changed to permit routing to Mobile Network AIM (or similar) (30B conceptually). To implement this additional advancement, the Improved Method and System for Short Message Service (SMS) Rating and Billing 40 need be augmented with an SMPP Relay 40A.

With reference again to FIG. 1, now for mobile terminated (MT) 10B Short Message Service (SMS) traffic a Short Message Peer to Peer (SMPP) Relay Module (SMPP RM) is provided for, which rates messages that are sent over an SMPP protocol connection to a given carrier's subscriber(s).

The SMPP Relay monitors messages sent via the SMPP protocol, intercepts and rates them accordingly (as per the RR defined prior); thereupon, the method and system 40 then makes a request to an Open Charging (OC) middleware platform and gateway system 50 as detailed in patent application Ser. No. 10/307335 to ensure

Prepaid subscribers have sufficient funds in their prepaid account before the MT SM gets sent to the relevant SMSC (beta). Where the account remains of insufficient balance, the message is rejected and is not sent to the SMSC beta. (The logic has been articulated such that messages to Postpaid subscriber's accounts are not intercepted, and are simply passed through to the SMSC beta for delivery). Technicians skilled in the art will recognize that the invention of present need not be limited to the aforementioned Open Charging (OC) middleware platform and gateway system and other similar network implementations may be employed without diluting the intent and scope as such.

Practitioners skilled in the art will recognize that the signaling systems mentioned remain for the purposes of illustration and simplicity, and that a variety of signaling systems, protocols and related technologies may be utilized without diluting the intent and scope of the invention of present. As an instance, the art can be articulated to accommodate for MT SMS traffic via a Universal Computer Protocol (UCP).

The Improved Method and System for Short Message Service (SMS) Rating and Billing, in alternate embodiments, supports the capability to notify subscribers of insufficient balances via SMS notification messages. Separate notification messages can be defined for messages that fail due to MO and MT insufficient balance scenarios.

For instance, for mobile terminated (MT) transactions, the so-labeled “Ensure Delivery and Re-credit Mode”, enables seamless and (for want of a better qualifier) perfect billing and charging for MT SMS messages. In this alternate embodiment, interaction with the SCP is required to permit re-crediting of susbcribers' account balances.

SM delivery receipts are used to guarantee delivery at the handset. If the message is indicated to be undelivered, the message is re-rated and re-credited to the subscriber's account. The logic of this, alternate, said message management mode allows a single SMPP transmitter and a single SMPP receiver connection per instance of the SMPP Relay. This requirement remains largely due to the Message Management mode requiring delivery receipts to be sent back to the content provider (optional).

The submit_sm message is rated by the Improved Method and System for Short Message Service (SMS) Rating and Billing 40. In the case of sufficient balance, the message is charged by the said system 40. The delivery receipt flag is also set by the system 40 before submission to the SMSC, if not already set by the submitting SMPP entity for messages from content providers defined in the content provider routing table. The delivery receipt is used for later re-crediting the subscriber's account in the case of unsuccessful delivery. After submission to the SMSC and receipt of the submit_sm_resp message from the SMSC, this message is propagated back to the submitting SMPP entity.

In the case of insufficient balance, the Improved Method and System for Short Message Service (SMS) Rating and Billing 40 generates a submit_sm_resp message back to the submitting SMPP entity to accept the message. Also, a so-labeled phase 1 delivery receipt is passed back to the receiver connected to the SMPP Relay instance to indicate the message was not delivered. The reason field in the phase 1 delivery receipt remains configurable.

In a further alternate embodiment, deliver receipts are the only deliver_sm messages processed by the system 40 for billing and charging purposes. Deliver_sm messages can be processed by the Content Provider routing table for correct routing the appropriate content provider. Delivery receipts received by the Improved Method and System for Short Message Service (SMS) Rating and Billing 40 indicating successful delivery are passed back the ESME. Receipts indicating unsuccessful delivery for postpaid subscribers are also passed back to the ESME. Receipts indicating unsuccessful delivery for prepaid subscribers are processed by the system 40. Said system 40 re-rates and re-credits the monies for the unsuccessfully delivered message back to the subscriber's account for content providers defined in the content provider routing table. The logic for this said re-crediting functionality described erstwhile may also be disabled in its entirety given the appropriate configuration parameter.

What is claimed is:

1. An improved method and system for Short Message Service (SMS) rating and billing.

2. The method of claim 1, which provides for real time rating of short messages.

3. The method of claim 2, which provides for the rating and billing of both mobile originated and mobile terminated short messages.

4. The method of claim 2, which rates short messages before they are submitted to the delivery Short Message Service Center (SMSC).

5. The method of claim 3, which provides for the rating and billing of mobile originated short messages.

6. The method of claim 5, whereby the art of present connects to telecommunications network operators' SMSCs and Mobile Switching Centers (MSCs) to receive mobile originated SMS traffic.

7. An improved and integrated series of rules designed to sort, classify and/or rate SMS traffic, in this instance.

8. The method of claim 7, whereby said rules are implemented as part of a computer program product, comprising:
a) a computer readable memory medium; and
b) a computer program including the logic required to implement those rules as such.

9. The method of claim 8, wherein such rules remain highly configurable and flexible given the dependencies and requirements in determining the short message tariff for a given subscriber.

10. The method of claim 9, where such rules may include originating or terminating address, time of day, day of week, holidays, inter alia.

11. The method of claims 7 and 8, where said short message traffic is rated according to the methods, rules and logic therein.

12. The method of claim 11, where the invention disclosed makes a request to an Open Charging (OC) middleware platform and gateway system or similar type of method, system and/or apparatus designed to ensure prepaid subscribers have sufficient funds in their account before the mobile originated short message gets sent to the relevant SMSC.

13. The method of claim 12, where upon determination of an insufficient balance, the short message is rejected and not delivered.

14. The method of claim 5, where a Short Message Peer to Peer (SMPP) protocol and relay system has been optionally employed to provide for mobile originated short message billing.

15. The method of claim 14, whereby the said SMSC routes all messages through the provided SMPP receiver interface.

16. The method of claim 15, where the SMSC is configured to route inbound SMs to a SMPP Receiver AIM, and additionally where the TON/NPI (Type-Of-Number and Numbering Plan Identification, respectively) are changed to permit routing to Mobile Network AIM (or similar).

17. The method of claim 3, which provides for the rating and billing of mobile terminated short messages.

18. The method of claim 17, where a Short Message Peer to Peer (SMPP) Relay Module (SMPP RM) is provided for, which rates messages that are sent over an SMPP protocol connection to a given carrier's subscriber(s).

19. The method of claim 18, where the provided for SMPP Relay monitors messages sent via said SMPP protocol.

20. The method of claim 19, where said system intercepts and rates the given short messages accordingly

21. The method of claims 7 and 20, where such messages are rated as per the rules thereof.

22. The method of claim 21, where the invention disclosed makes a request to an Open Charging (OC) middleware platform and gateway system or similar type of method, system and/or apparatus designed to ensure prepaid subscribers have sufficient funds in their account before the mobile originated short message gets sent to the relevant SMSC.

23. The method of claim 22, where upon determination of an insufficient balance, the short message is rejected and not delivered.

24. The method of claim 3, wherein mobile/wireless subscribers can be notified of insufficient balance scenarios via SMS notification messages.

25. The method of claim 24, where separate notification messages may be defined for messages that fail due to MO and MT insufficient balance scenarios.
